(19) United States
(12) Patent Application Publication
(10) Pub. No.: US 2024/0046285 A1
(43) Pub. Date: Feb. 8, 2024

(54) INFORMATION ANALYSIS DEVICE AND INFORMATION ANALYSIS METHOD

(71) Applicant: Panasonic Intellectual Property Management Co., Ltd., Osaka (JP)

(72) Inventors: Takao ADACHI, Hyogo (JP); Hidehiko SHIN, Osaka (JP)

(21) Appl. No.: 18/378,747

(22) Filed: Oct. 11, 2023

Related U.S. Application Data
(63) Continuation of application No. PCT/JP2022/004286, filed on Feb. 3, 2022.

(30) Foreign Application Priority Data
Apr. 28, 2021 (JP) 2021-076143

(51) Int. Cl. G06Q 30/0201

(52) U.S. Cl. CPC G06Q 30/0201

(57) ABSTRACT

An information analysis device for displaying information on a moving object in plural areas corresponding to plural facilities, includes: a display configured to display information; an input interface configured to receive a user operation; a processor configured to control the display, based on the user operation received by the input interface; and a memory configured to store status information indicating a state where each facility in the plural facilities operates, and detection information indicating a detection result of the moving object in each area in the plural areas. The processor is configured to: receive, via the input interface, a status information operation designating information on a specific facility in the status information on the plural facilities; and limit information to be displayed among the status information on the plural facilities and the detection information on the plural areas, based on information on the facility designated by the status information operation.

### BACKGROUND

The present disclosure relates to an information analysis device and an information analysis method.

JP 2016-207059 A discloses a behavior analysis system that displays a combination of information obtained by processing trajectory information, sales information, and the like on a screen to provide information useful for considering measures for store improvement. This behavior analysis system determines staying in each area in a store in the trajectory information with reference to passage area information, and graphically displays the number of staying times in each area and a total number of purchases or a total purchase price with them being superimposed on a store layout. According to such a behavior analysis system, information obtained from the trajectory information and transaction information can be viewed in association with each other.

### SUMMARY

The present disclosure provides an information analysis device capable to facilitate for a user to analyze information displayed regarding a plurality of facilities and moving objects.

The present disclosure provides an information analysis device for displaying information on a moving object in plural areas corresponding to plural facilities, the information analysis device including: a display configured to display information; an input interface configured to receive a user operation; a processor configured to control the display, based on the user operation received by the input interface; and a memory configured to store status information and detection information, the status information indicating a state where each facility in the plural facilities operates, and the detection information indicating a detection result of the moving object in each area in the plural areas, wherein the processor is configured to: receive a status information operation via the input interface, the status information operation designating information on a specific facility in the status information on the plural facilities; and limit information to be displayed on the display among the status information on the plural facilities and the detection information on the plural areas, based on information on the specific facility designated by the status information operation.

These general and specific aspects may be implemented by a system, a method, and a computer program, and a combination thereof.

According to the information analysis device of the present disclosure, it can be facilitated for a user to analyze information displayed regarding a plurality of facilities and a moving object.

### BRIEF DESCRIPTION OF DRAWINGS

FIG. 1 is a diagram illustrating an overview of a trajectory analysis system according to a first embodiment of the present disclosure;

FIG. 2 is a block diagram illustrating a configuration of an information analysis device in the trajectory analysis system;

FIG. 3 is a table for describing trajectory data in the trajectory analysis system;

FIG. 4 is a diagram for describing map information in the trajectory analysis system;

FIG. 5 is a table for describing facility operation data in the trajectory analysis system;

FIG. 6 is a graph illustrating timelines in the information analysis device;

FIGS. 7A and 7B are diagrams for describing analysis screens in the information analysis device;

FIG. 8 is a flowchart illustrating an operation of the information analysis device;

FIG. 9 is a diagram illustrating a display example of a video using a timeline in the information analysis device;

FIG. 10 is a flowchart illustrating timeline filtering processing to be executed by the information analysis device according to the first embodiment;

FIG. 11 is a diagram for describing a method for counting the number of traffic in the trajectory analysis system;

FIG. 12 is a table illustrating traffic information in the trajectory analysis system;

FIG. 13 is a graph illustrating a setting menu of a narrowing-down condition in the information analysis device according to a second embodiment;

FIG. 14 is a graph illustrating a setting menu of a display order condition in the information analysis device according to the second embodiment;

FIG. 15 is a flowchart illustrating timeline filtering processing to be executed by the information analysis device according to the second embodiment;

FIG. 16 is a table for describing responsibility information in the trajectory analysis system; and

FIG. 17 is a table for describing information on a person responsible for maintenance in the trajectory analysis system.

### DETAILED DESCRIPTION

Hereinafter, embodiments will be described in detail with reference to the drawings as appropriate. However, more detailed description than necessary may be omitted. For example, detailed descriptions of already well-known matters and duplicate descriptions for substantially the same configuration may be omitted. This is to avoid unnecessary redundancy of the following description and to facilitate the understanding of those skilled in the art.

It should be noted that the applicant(s) provides the accompanying drawings and the following description in order that those skilled in the art fully understand the present disclosure, and does not intend the provided drawings and description limit the subject matter described in the claims.

### First Embodiment

A first embodiment of the present disclosure will be described below with reference to the drawings.

1. Configuration

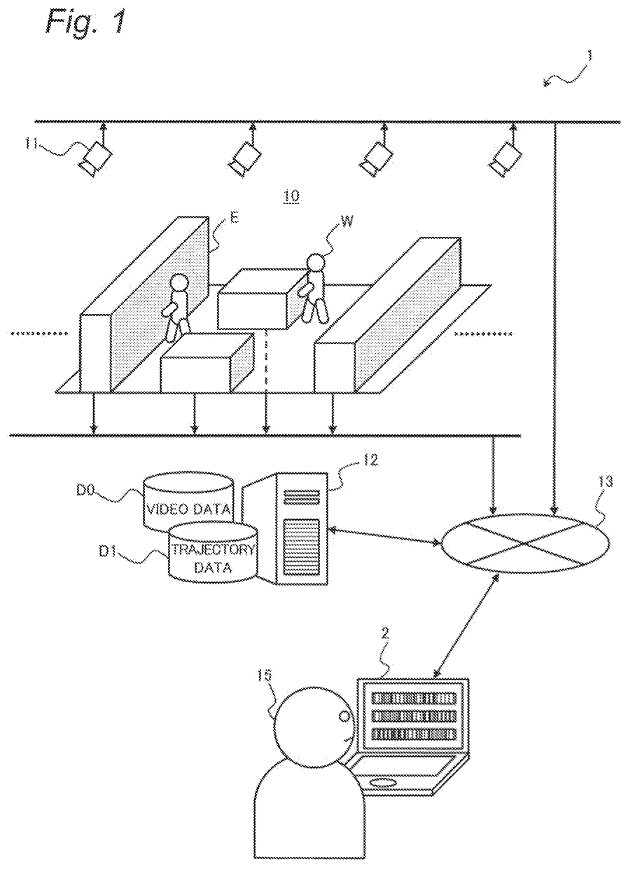

A system using an information analysis device according to the first embodiment will be described with reference to FIG. 1.

1-1. Trajectory Analysis System

FIG. 1 illustrates an overview of a trajectory analysis system 1 according to the present embodiment. As illustrated in FIG. 1, the system 1 includes a plurality of cameras 11, a trajectory management server 12, and an information analysis device 2, for example. The system 1 accumulates information on a trajectory that is a locus along which one or more workers W have moved in a workplace 10 provided with various facilities E in a factory, a distribution warehouse, a store, or the like.

The present embodiment will describe an example where the trajectory analysis system 1 is applied to the workplace 10 including the plurality of facilities E where a plurality of workers W works. For example, the system 1 is applicable to data analysis in which a user 15 such as a manager of the workplace 10 or a person responsible for analysis analyzes a factor that has deteriorated work efficiency during operations of the facilities E, that is, a bottleneck. The respective units of the system 1 is connected to a communication network. 13 such as a local area network (LAN), a wide area network (WAN), or the Internet, and can perform data communication.

The facilities E in the workplace 10 each have a function of recording data indicating a history of an operation of the own machine in various recording media, for example. The facilities E each may include a communication device that is connected to the communication network 13 and can transmit the recorded data to the outside. The facilities E or their communication device may be included in the system 1.

In the system 1, the cameras 11 are disposed so as to capture images that cover ranges including the respectively facilities E or the like in the workplace 10. For example, the cameras 11 are communicably connected to the trajectory management server 11 via the communication network 13 so as to be able to transmit video data D of the imaged result of the workplace 10. The cameras 11 may be omnidirectional cameras, box cameras, or the like.

The trajectory management server 12 is a server device including a storage or the like that accumulates and manages information such as the video data DO of the imaged results obtained by the respective cameras 11 and trajectory data D1 indicating various trajectories based on the video data DO. The trajectory management server 12 may further manage the operation statuses of the facilities E in the workplace 10 as data.

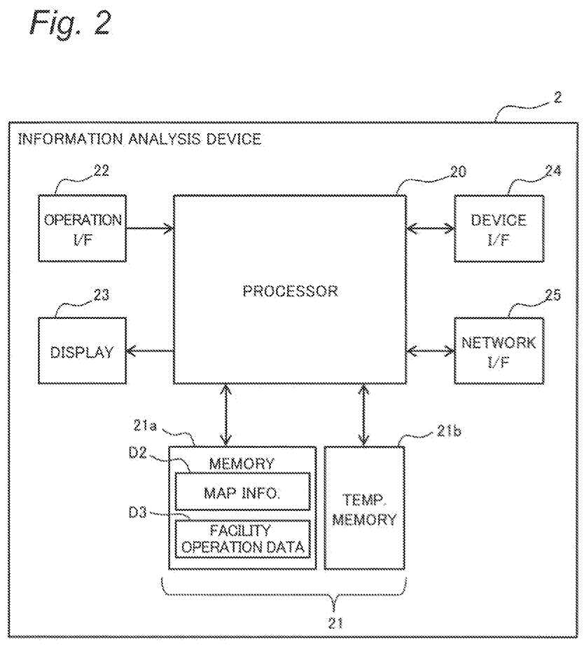

The information analysis device 2 according to the present embodiment presents information to be used for analysis by the user 15 from the accumulated information such as the video data DO and the trajectory data D1 in the system 1. The information analysis device 2 includes an information processing device such as a personal computer (PC). A configuration of the information analysis device 2 will be described with reference to FIG. 2,

1-2. Configuration of Information Analysis Device

FIG. 2 is a block diagram illustrating the configuration of the information analysis device 2. The information analysis device 2 illustrated in FIG. 2 includes a processor 20, a memory 21, an operation interface 22, a display 23, a device interface 24, and a network interface 25. Hereinafter, an interface may be abbreviated as an “I/F”.

The processor 20 includes a central processing unit (CPU) or a microprocessor unit (MPU) that cooperates with software to implement predetermined functions. The processor 20 controls the overall operation of the information analysis device 2, for example. The processor 20 reads the data and the programs stored in the memory 21, and performs various operation processing to implement various functions.

For example, the processor 20 executes a program including a command set for executing the various functions. The above programs may be provided from the communication network 13 or may be stored in a portable recording medium. The processor 20 may be a hardware circuit such as a dedicated electronic circuit or a reconfigurable electronic circuit designed to perform the various functions. The processor 20 may be configured with various semiconductor integrated circuits such as a CPU, an MPU, a graphics processing unit (GPU), a general purpose graphics processing unit (GPGPU), a time processing unit (TPU), a microcomputer, a digital signal processor (DSP), a field-programmable grid array (FPGA) and an application specific integrated circuit (ASIC).

The memory 21 is a storage medium that stores programs and data necessary for implementing the functions of the information analysis device 2. As illustrated in FIG. 2, the memory 21 includes a storage 21a and a temporary memory 21b.

The storage 21a stores parameters, data, control programs, and the like for achieving predetermined functions. The storage 21a includes a hard disk drive (HDD) or a solid state disk (SSD). The storage 21a stores the above-described programs, map information D2, facility operation data D3, and the like. The map information D2 indicates the layout of the respective facilities E and the like in the workplace 10 in a predetermined coordinate system. The facility operation data D3 indicates histories of operating states where the facilities E operate in the workplace 10. Details of the various data will be described later.

The temporary memory 21b includes a random access memory (RAM) such as a dynamic RAM (DRAM) or a static RAM (SRAM), and temporarily stores (i.e., holds) data. For example, the temporary memory 21b holds the trajectory data D and the video data DO received from the trajectory management server 12 (FIG. 1), various timelines to be described later, and the like. In addition, the temporary memory 21b may function as a work area of the processor 20, and may be configured with a storage area in an internal memory of the processor 20.

The operation interface 22 is a general term of an operation member operated by a user. The operation interface 22 may be a keyboard, a mouse, a touch pad, a touch panel, a button, a switch, or the like. The operation interface 22 is an example of an input interface that acquires various information input by a user operation.

The display 23 is an example of an output interface configured with, a liquid crystal display or an organic electroluminescence (EL) display, for example. The display 23 may display various information such as various icons for operating the operation interface 22 and information input from the operation interface 22.

The device I/F 24 is a circuit for connecting an external device to the information analysis device 2. The device I/F 24 performs communication according to a predetermined communication standard. The predetermined standard includes Universal Serial Bus (USB), High-Definition Multimedia Interface (HDMI: registered trademark), Institute of Electrical and Electronic Engineers (IEUE) 1395, WiFi, and Bluetooth. The device I/F 24 may constitute an input interface that receives various information from an external device in the information analysis device 2 or an output interface that transmits various information to the external device.

The network I/F 25 is a circuit for connecting the information analysis device 2 to the communication network 13 via a wireless or wired communication line. The network IF 25 performs communication according to a predetermined communication standard. The predetermined communication standard includes communication standards such as IEEE 802.3 and IEEE 802.11a/11b/11g/11ac. The network I/F 25 may constitute an input interface that receives various information or an output interface that transmits various information via the communication network 13 in the information analysis device 2.

The configuration of the information analysis device 2 as described above is an example, and the configuration of the information analysis device 2 is not limited thereto. For example, the information analysis device 2 may include various computers including a server device. The information analysis device 2 may be configured integrally with the trajectory management server 12.

In addition, the input interface in the information analysis device 2 may be implemented by cooperation with various software in the processor 20 or the like. The input interface in the information analysis device 2 may acquire various information by reading various information stored in various storage media (e.g., the storage 21a) to a work area (e.g., the temporary memory 21b) of the processor 20.

Further, various display devices such as a projector and a head mount display may be used as the display 23 of the information analysis device 2. For example, in a case where an external display device is used, the display 23 of the information analysis device 2 may be an output interface circuit for a video signal or the like conforming to the HDMI (registered trademark) standard or the like.

1-2-1. Data Structure

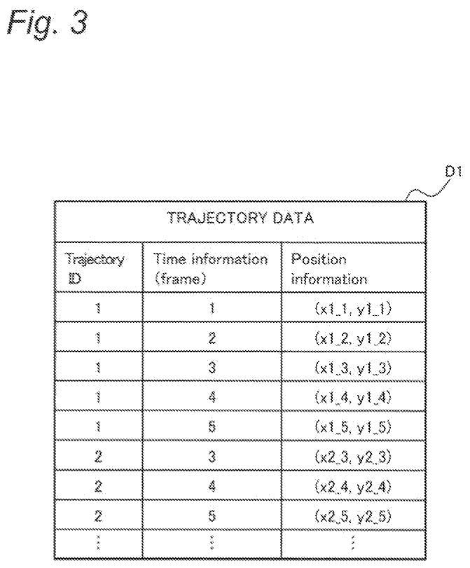

Structures of various data stored in the information analysis device 2 and the like in the system 1 will be described with reference to FIGS. 3 to 5.

FIG. 3 is a table for describing the trajectory data D1 in the system 1. The trajectory data D1 includes a trajectory ID, time information, and position information in association with each other. The trajectory ID indicates identification numbers of individual trajectories. The time information is represented by a frame number of the corresponding video data D0, for example. The position information indicates the position of a moving object such as the worker W in the coordinate system (X, Y) of the map information D2.

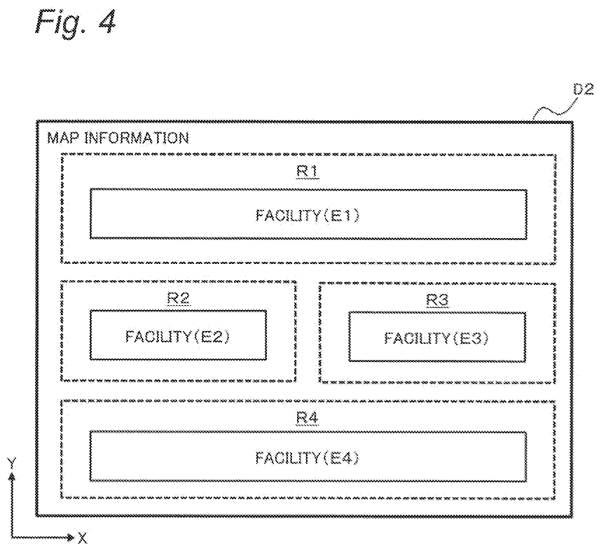

FIG. 4 is a diagram for describing the map information D2 in the system 1. The map information D2 illustrated in FIG. 4 includes ranges of a plurality of facilities E1 to E4 disposed in the workplace 10 and coordinate positions of work areas R1 to R4 corresponding to the facilities E1 to E4, respectively, in the coordinate system (X, Y) set in advance in accordance with the workplace 10. Hereinafter, the facilities E1 to E4 are generally referred to as the facility E, and the work areas R1 to R4 are generally referred to as the work area R. Each work area R is an area where one or the plurality of workers W is assumed to do work for each corresponding facility E, and is set in a corresponding imaging range of the individual camera 11, for example. In addition, although the four facilities E1 to E4 are illustrated in FIG. 4, the number of the facilities E in the workplace 10 is not particularly limited, and may be more number. The number of the facilities E may be three or less.

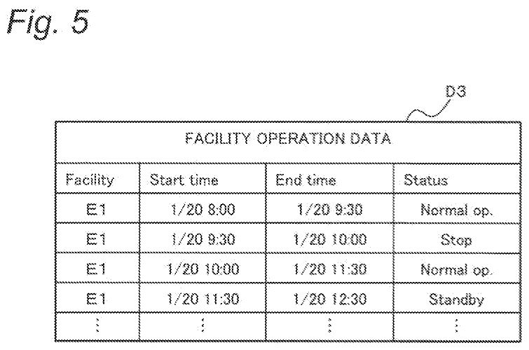

FIG. 5 is a table for describing the facility operation data D3 in the system 1. The facility operation data D3 includes identification information regarding the facility E, time information including a start time and an end time, and a status indicating an operation state in association with each other. For example, a user 15 of the information analysis device 2 records operation data of each facility E in a portable recording medium (e.g., a memory card) in advance, and inputs the operation data from the recording medium to the information analysis device 2 via the device I/F 24 or the like. As a result, the information analysis device 2 can acquire the facility operation data D3.

2. Operation

The operations of the trajectory analysis system 1 and the information analysis device 2 configured as described above will be described below.

2-1. System Operation

In the trajectory analysis system 1 (FIG. 1) of the present embodiment, the plurality of cameras 11 sequentially images the work areas R in the respective imaging ranges for each frame during the operations of the facilities E in the workplace 10, and transmits the video data DO to the trajectory management server 12, for example.

The trajectory management server 12 receives the video data DO from the respective cameras 11, and stores the video data DO in the storage of the trajectory management server 12. The trajectory management server 12 performs image recognition for recognizing the position of the worker W in the captured images for each frame indicated by the video data DO from the cameras 11, generates the trajectory data D1, and stores the trajectory data D1 in the storage.

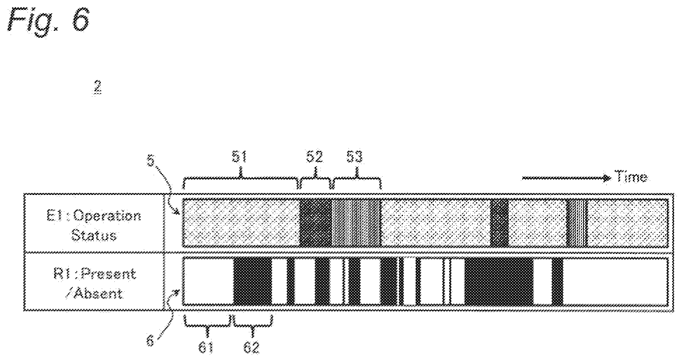

For example, the information analysis device 2 acquires data indicating the operation statuses of the facilities E during the imaging in the system 1 from the various I/Fs 24 and 25 (FIG. 2), and stores the data in the memory 21 as facility operation data D3. The information analysis device 2 performs data communication with the trajectory management server 12, and receives various information from the trajectory management server 12 in accordance with an operation by user 15. The information analysis device 2 generates various information to be used by the user 15 for analysis in the workplace 10 and the like, based on the information acquired as described above, and displays the various information on the display 23. Such an example is illustrated in FIG. 6.

FIG. 6 is a graph illustrating timelines 5 and 6 in the information analysis device 2. In FIG. 6, the operation timeline 5 related to one facility E11 and the staying timeline 6 related to the work area R1 corresponding to the facility E1 are displayed. The timelines 5 and 6 each indicate information to be analyzed in chronological order.

The operation timeline 5 is an example of status information indicating a past operation status of each facility E using time-based spans. For example, the operation timeline 5 is configured by sequentially arranging a normal operation span 51, an error stop span 52, and a standby span 53 in chronological order. The normal operation span 51 is a time span indicating a state where the corresponding facility E normally operates. The error stop span 52 is a time span indicating a state where the corresponding facility E stops due to an error. The standby span 53 is a time span indicating a state where the corresponding facility E stands by for switching, preparation, or the like of work. In FIG. 6, portions having identical hatching among the time spans denoted by reference numerals 51, 52, and 53 indicate the same type of time spans. In the operation timeline 5, the various time spans 51 to 53 are displayed in different colors, for example.

The staying timeline 6 is an example of detection information indicating a detection result of the staying situation such as the presence or absence of the worker W in the corresponding one work area R using a time span. For example, the staying timeline 6 includes a staying span 61 and an absence span 62. The staying span 61 is a time span where the presence of one or more workers W is detected in the work area R. The absence span 62 is a time span where the presence of worker W is not detected in the work area R. In FIG. 6, portions having identical hatching among the time spans denoted by reference numerals 61 and 62 indicate the same type of time spans. In the staying timeline 6, the various time spans 61 and 62 are displayed in different colors, for example.

For example, the staying timeline 6 configures link information of the video data DO indicating the imaging result of the corresponding work area R. Such video data DO is an example of the related predetermined information on the staying timeline 6.

According to the timelines 5 and 6 as described above, both the operation status of the facility E and the staying status of the worker W in the corresponding work area R are visualized in chronological order. For example, this is useful for analyzing the operation efficiency in the facility E. The present embodiment provides user interfaces that facilities of the analysis of the timelines 5 and 6 as described above with respect to a large number of the facilities E and work areas R in the workplace 10.

2-2. Timeline Analysis Screen

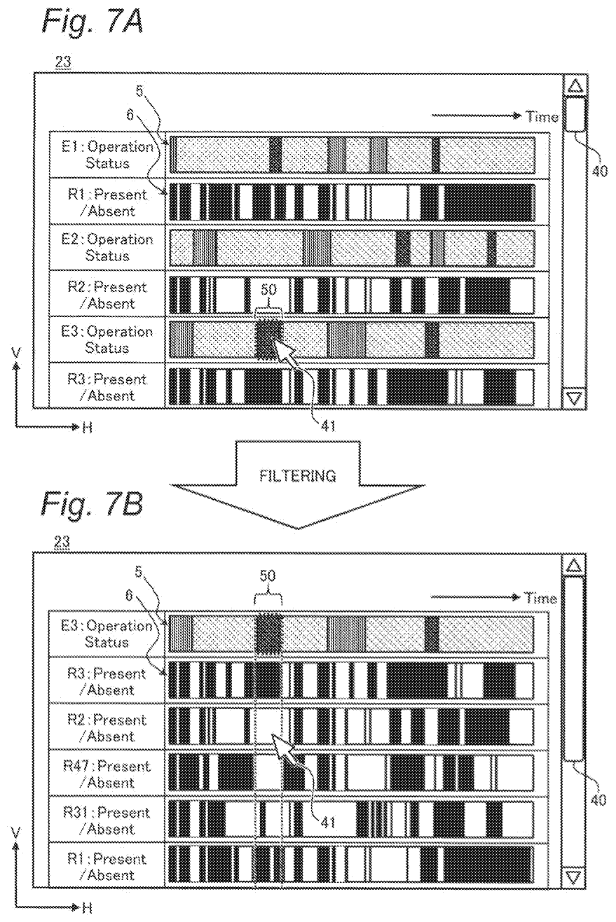

An analysis screen for displaying the timelines 5 and 6 in the information analysis device 2 of the present embodiment will be described with reference to FIGS. 7A and 7B.

FIGS. 7A and 7B are diagrams illustrating display examples of the timelines 5 and 6 in the information analysis device 2 before and after filtering. Hereinafter, on the analysis screen displayed by the display 23 of the information analysis device 2, the coordinate in a horizontal direction H is referred to as an 1H coordinate, and the coordinate in a vertical direction V is referred to as a V coordinate. In such image coordinates (H, V), a +V side may be referred to as an upper side, and a −V side may be referred to as a lower side.

On the analysis screen illustrated in FIGS. 7A and 78, the operation timelines 5 and the staying timelines 6 related to the various facilities E and their work areas R are arranged in the vertical direction V with the respective time axes being aligned with the horizontal direction H. Furthermore, in the present display example, a scroll bar 40 is provided to sequentially display the timelines 5 and 6 that do not fall within a displayable range on the analysis screen from the top. The scroll bar 40 has a movable range within which the scroll bar 40 is slidable in accordance with the number of target timelines 5 and 6 to be displayed, and operates to receive a user operation for sequentially sliding the timelines 5 and 6 to be displayed, that is, a sliding operation.

The analysis screen illustrated in FIG. 7A includes, as an entire display for a predetermined period such as one day, the timelines 5 and 6 of all the facilities E in the workplace 10 as display targets. For example, sets of the operation timeline 5 and the staying timeline 6 are sequentially arranged for each facility E. In the example of FIG. 7A, as there are a large number of the timelines 5 and 6 to be displayed, the movable range of the scroll bar 40 is set to be relatively wide.

An exemplary case is that for analyzing the bottleneck of the workplace 10, the user 15 may desire to analyze the worker W or the like staying in the work area R of another facility E in the error stop span 52 or the like of the specific facility E. In such a case, a complicated situation may occur if, on the analysis screen of the entire display (FIG. 7A), that the user 15 sequentially confirms the presence or absence of the worker W in each work area R while repeating the sliding operation over a large number of the timelines 5 and 6. Therefore, only with the analysis screen as described above, it is conceivable that a load is excessive when the user 15 conducts the desired analysis.

Therefore, the information analysis device 2 of the present embodiment is operable to receive an operation for designating a time span of the facility E desired to be analyzed by the user 15 in the operation timeline 5 on the analysis screen being displayed, and performs filtering to limit the timelines 5 and 6 to be displayed, for example. FIG. 7B illustrates an example of an analysis screen displayed as a filtering result by the information analysis device 2.

FIG. 7B illustrates a display example of the filtering result in a case where the time span 50 such as the specific error stop span 52 (FIG. 6) in the specific facility E3 is designated by the user operation in the display example of FIG. 7A. As an example of the filtering based on the designation operation on the operation timeline 5, the information analysis device 2 performs narrowing-down such as excluding the operation timelines 5 of the facilities E other than the designated facility E3 from the display target. According to this, the analysis load can be reduced by decreasing the information presumed not to be the analysis target of the user 15 to collectly display the information that is probable to be the analysis target. Further, in the present embodiment, the analysis load can be easily reduced by performing display limitation such as rearranging the display order or narrowing down the display target as for the staying timeline 6.

2-3. Operation of Information Analysis Device

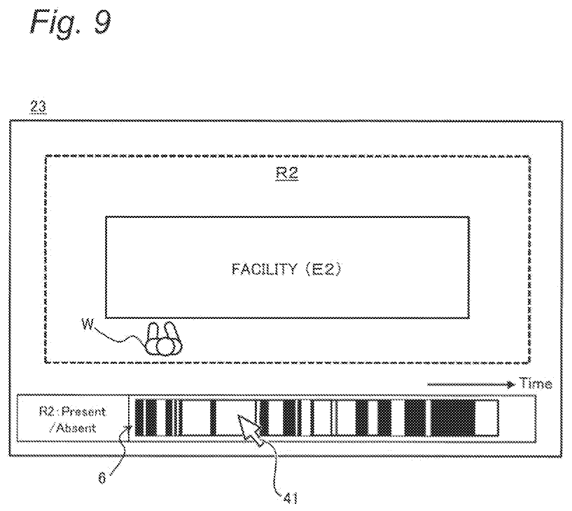

The operation of the information analysis device 2 that provides the user interfaces described above will be described with reference to FIGS. 5 and 9.

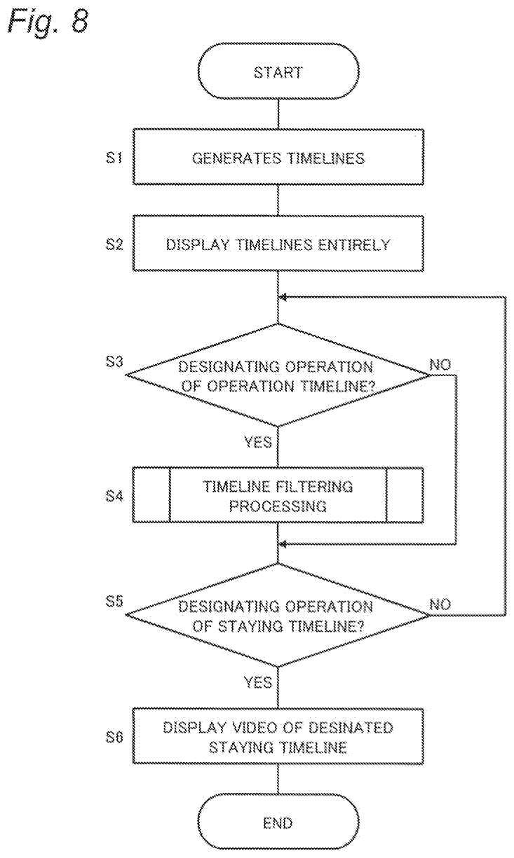

FIG. 8 is a flowchart illustrating the operation of the information analysis device 2. The processing illustrated in the flowchart of FIG. 8 is started in a state where the facility operation data D3 and the like are acquired, and is performed by the processor 20 of the information analysis device 2.

First, the processor 20 of the information analysis device 2 generates the operation timelines 5 of all the facilities E based on the facility operation data D3 for a predetermined period (S1). The predetermined period is a period preset as a display target, such as the past one day.

For example, the processor 20 also generates the staying timelines 6 for all the work areas R, based on the trajectory data D1 and the map information D2 (S1). For example, the processor 20 acquires the trajectory data D1 for the same period as the operation timeline 5 from the trajectory management server 12. For example, the processor 20 detects position coordinates included in the respective work areas R in the acquired trajectory data D1 for each time, and generates the staying timelines 6 of the work areas R. The processor 20 holds the generated various timelines 5 and 6 in the memory 21.

For example, the processor 20 then displays an analysis screen of the entire display on the display 23 as illustrated in FIG. 7A, based on the generated timelines 5 and 6 (S2). The processor 20 causes the operation interface 22 to receive a user operation for each of the timelines 5 and 6 displayed on the display 23 (S3 and S5). The target user operations in steps S3 and S5 specify desired positions on the timelines 5 and 6 by a click operation using a pointer 41, for example.

For example, when the designating operation of the operation timeline 5 is input (YES in S3), the processor 20 executes processing for filtering the timelines 5 and 6 (S4). In the filtering processing (S4) of the timelines 5 and 6, the timelines 5 and 6 to be displayed are narrowed down or the display order is controlled, for example. As a result, the display target of the analysis screen is limited to the filtering result as illustrated in FIG. 78. Details of the processing in step S4 will be described later.

When the designating operation of the staying timeline 6 is input (YES in S5), the processor 20 causes the display 23 to display the video of work area R corresponding to the designated staying timeline 6 (S6). A display example in step S6 is illustrated in FIG. 9.

In the example of FIG. 9, the display 23 displays a video captured near a specific time in the work area R2 of the facility E2 corresponding to the staying timeline 6 designated in FIG. 7B. For example, in the designating operation of the staying timeline 6 (S5), the processor 20 specifies the work area R2 and a time corresponding to the designated staying timeline 6, based on the image coordinates (11, V) input through the pointer 41. For example, the processor 20 receives the video data DO of the work area R corresponding to the designated staying timeline 6 from the trajectory management server 12, and displays the video at the designated time (S6).

In the example of FIG. 9, in the staying timeline 6 corresponding to the video, the imaging result of the worker W whose staying is detected can be checked on the video. Such a video is an example of relevant information associated with the staying timeline 6. The video displayed in step S6 may be a moving image or a still image. For example, when the video is displayed by the designating operation of the staying timeline 6 as described above (S5 and S6), the staying timeline 6 that is a candidate of the video display can efficiently be presented by the timeline filtering processing (S4) (see FIG. 73).

In addition, the user 15 may again perform the designating operation of the operation timeline 5 before performing the operation for designating the displayed staying timeline 6 on the analysis screen of the filtering result (FIG. 7B) (NO in S5 and YES in S3). For example, the user 15 may further designate a time span different from the time span designated for the first time in the operation timeline 5 as the second designating operation of the operation timeline 5. In this case, the processor 20 again performs the processing in step S4 on the timelines 5 and 6 that are display targets limited for the first time to further limit the display target, for example.

For example, the processor 20 causes the display 23 to display a video (S6), and terminates the processing illustrated in this flowchart.

According to the above processing as an example, when the video of the work area R corresponding to the staying timeline 6 is displayed (S6), the staying timeline 6 corresponding to the video desired to be checked by the user 15 can be easily searched by the timeline filtering processing (S4).

2-3-1. Timeline Filtering Processing

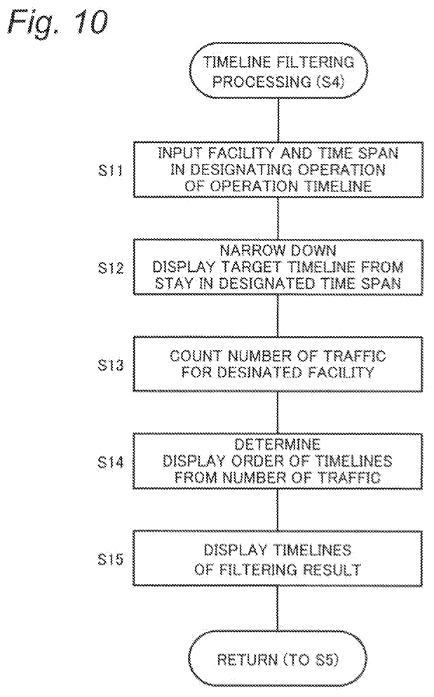

Details of the processing in step S4 in FIG. 8 will be described with reference to FIG. 10. Hereinafter, as an example of the timeline filtering processing (S4), an example will be described in which the staying of the worker W is used as a condition for narrowing down the display target, and the traffic between the work areas R1 to R4 are used as a condition for setting the display order.

FIG. 10 is a flowchart illustrating the timeline filtering processing (S4 in FIG. 8) to be executed by the information analysis device 2 according to the present embodiment. The processing of this flow is executed by the processor 20 of the information analysis device 2 when the designating operation of the operation timeline 5 is performed (YES in S3) while the analysis screen illustrated in FIG. 7A is displayed, for example.

First, the processor 20 inputs information indicating the facility E and the time span 50 designated in the operation (S3 in FIG. 8) for designating the operation timeline 5 from the operation interface 22 (S11). For example, on the analysis screen illustrated in FIG. 7A, the processor 20 designates the facility E3 and the time span 50 corresponding to the designated operation timeline 5, based on the image coordinates (H, V) input through the pointer 41.

For example, the processor 20 narrows down the timelines 5 and 6 to be displayed on the analysis screen after filtering, based on the input information (S12). For example, the processor 20 excludes the operation timelines 5 related to the facilities E other than the facility E3 designated in the designating operation of the operation timeline 5 from the display target.

The present example will describe a case where the narrowing-down condition of the staying timeline 6 is that the worker W stays in the time span 50 designated in the corresponding work area R. In this case, the processor 20 excludes, from the display target, the staying timeline 6 that includes only the absence spans 62 (FIG. 6) as the time spans 50, that is, does not include the staying span 61 (S12). Note that the staying timeline 6 in the work area R3 of the designated facility E3 may be included in the display target regardless of the narrowing-down condition as described above.

In addition, the present example will describe a case where the condition of the display order of the staying timelines 6 is the order in which the number of times the worker W moves as traffic between the work area R3 corresponding to the designated facility E3 and the other work areas R is large. For example, the processor 20 counts the number of traffic based on the trajectory data D1 for a predetermined period such as one day (S13). A method for counting the number of traffic will be described later.

The processor 20 determines the order in which the timelines 5 and 6 to be displayed are displayed, on the analysis screen after filtering (FIG. 71), based on the counted number of traffic, for example (S4). For example, the processor 20 determines the operation timeline 5 of the designated facility E3 as the first-order display target, sets the staying timeline 6 in the work area R3 of the designated facility E3 as the second-order display target, and determines the order of the residual staying timelines 6 to be displayed as subsequent display targets. At this time, according to the condition of the display order described above in the present example, the processor 20 gives a higher display priority to the staying timeline 6 related to the greater number of traffic in the work area R.

For example, as illustrated in FIG. 7B, the processor 20 causes, based on the above processing result, the display 23 to display the narrowed-down timelines 5 and 6 to be displayed in the determined display order on the analysis screen after filtering (S5). As a result, the processor 20 completes the processing of step S4 in FIG. 8 and the processing proceeds to step S5.

According to the timeline filtering processing (S4) as described above, the analysis using the timelines 5 and 6 can be facilitated by the display limitation such as narrowing-down of the timelines 5 and 6 to be displayed and controlling of the display order.

For example, when the user 15 analyzes the specific time span 50 such as the specific error stop span 52 in the specific facility E3 as a bottleneck of the workplace 10 (FIGS. 6.7A and 7B), a case is considered where the user desires to check the situation of the work area R where the worker W has stayed in the time span 50. Among such work areas R, the work area R where the worker W frequently moves to and from the facility E3 to be analyzed is expected to be highly related to the bottleneck to be analyzed. In such a case, according to the filtering processing (FIG. 10) of the timeline using the condition of the narrowing-down and the display order described above, the staying timeline 6 of only the display target useful as a display bottleneck analysis target is displayed. This makes it possible for the user 15 to efficiently conduct the analysis.

2-3-2. The Number of Traffic

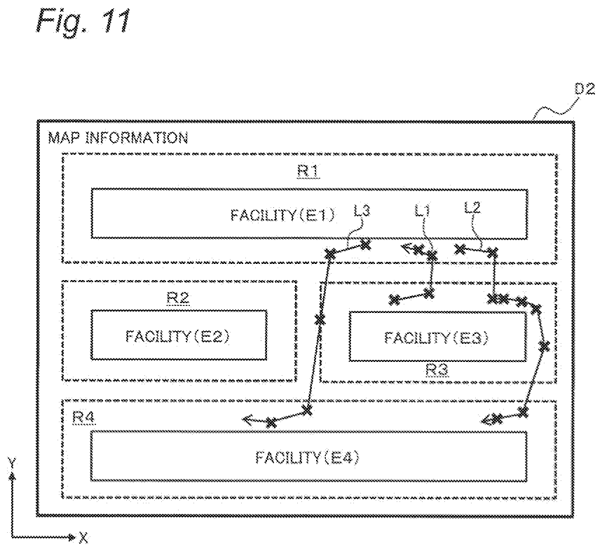

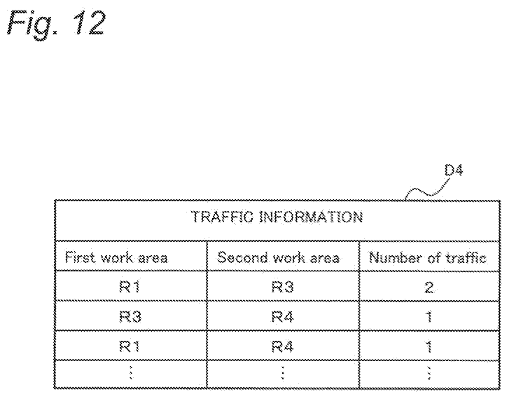

The method for counting the number of traffic in this system 1 will be described with reference to FIGS. 11 and 12.

FIG. 11 illustrates positions of various trajectories L1, L2, and L3 in the map information D2. The trajectory L1 includes position coordinates included in the work areas R1 and R3 in order. The trajectories L2 and L3 each include position coordinates included in the work areas R1, R3, and R4 in order. A period during which the trajectory L2 stays in the work area R3 is relatively long, and a period during which the trajectory L3 stays in the work area R3 is relatively short.

FIG. 12 illustrates traffic information D4 in the information analysis device 2. The traffic information D4 manages the first and second work areas and the number of traffic in association with each other. The number of the traffic is the number of times the worker W has moved from the first work area to the second work area or has moved from the second work area to the first work area. The number of traffic based on the trajectory data D1 for a predetermined period indicates a frequency of movement of the worker W between the first and second work areas during the period.

For example, in step S13 of FIG. 10, the processor 20 of the information analysis device 2 increments the number of traffic between the work areas R1 and R3 by one based on the position information in the data of the trajectory ID corresponding to the trajectory L1 in the trajectory data D1, in addition, based on the data of the trajectory 12, the processor 20 increments the number of traffic between the work areas R1 and R3 by one, and increments the number of traffic between the work areas R3 and R4 by one.

In the example of FIG. 11, the trajectory L3 exemplifies a case where the worker W passes the work area R3 on the way between the work area R1 and the work area R4. In such a case, it is considered that the detection can be made based on a staying period in the work area R3 on the way. For example, the processor 20 detects that the staying period in the work area R3 on the way is shorter than a preset threshold, based on the data of the trajectory L3, and increments the number of traffic between the work areas R1 and R4 by one. According to such counting of the number of traffic, the traffic information D4 as illustrated in FIG. 12 is acquired. The traffic information D4 is stored in the memory 21 of the information analysis device 2, for example.

In step S13 of FIG. 10, only the number of traffic related to the work area R3 of the designated facility E3 may be selectively counted. The counting of the number of traffic described above is not limited to step S13, and may be performed at the time of step S1 in FIG. 8, for example. The execution subject that counts the number of traffic is not limited to the information analysis device 2, and may be the trajectory management server 12, for example. In this case, the processor 20 can acquire the traffic information D4 from the trajectory management server 12 and perform the processing in and after step S14 instead of step S13.

### 3. SUMMARY

As described above, in the present embodiment, the information analysis device 2 displays information on the worker W, which is an example of the moving object in the plurality of work areas R, which is an example of the plurality of areas respectively corresponding to the plurality of facilities E. The information analysis device 2 includes the display 23, the operation interface 22 as an example of the input interface, the processor 20, and the memory 21. The display 23 displays information. The operation interface 22 receives a user operation. The processor 20 controls the display 23 based on the user operation input through the operation interface 22, The memory 21 stores the operation timeline 5 as an example of the status information indicating a state where each facility E in the plurality of facilities E operates, and the staying timeline 6 as an example of the detection information indicating the detection result of the moving object in each area in the plurality of areas. The processor 20 causes the operation interface 22 to receive the designating operation of the operation timeline 5 as an example of status information operation for designating the information on the specific facility E in the operation information on the plurality of facilities E (S3). The processor 20 limits information to be displayed on the display 23 in the operation information on the plurality of facilities E and the detection information on the plurality of areas, based on the information on the facility E designated in the operation in the operation information (S4).

According to the information analysis device 2 described above, the information to be displayed on the display 23 in the operation information on the plurality of facilities E and the detection information on the plurality of areas is limited in accordance with the information on the facility E designated in the operation in the operation information. This makes it possible for the user 15 to easily analyze the information displayed regarding the plurality of facilities E and the moving object. According to such display limitation, the user IS can easily view and recognize the information on the analysis measures, and eventually, various analysis loads on the information analysis device 2 can be reduced.

In the present embodiment, the plurality of operation timelines 5 as an example of the operation information on the plurality of facilities E each include various time spans in which each facility E is in a predetermined state (see FIG. 6). The information on the facility E designated in the operation in the operation information indicates the time span 50 where the facility E is in the predetermined state. In the timeline filtering processing (S4), as an example as illustrated in FIG. 7B, the processor 20 causes the limited detection information to be displayed on the display 23 to include the detection result of the moving object in the time span 50 designated in the operation in the operation information. As a result, the user 15 can check the detection result of the moving object in each area in the designated time span 50 in the state where the display limitation is performed, and can easily conduct desired information analysis.

In the present embodiment, the processor 20 may limit the information to be displayed on the display 23, based on the detection result of the moving object in the designated time span 50 in each area in the staying timelines 6 of the plurality of work areas R, which are the detection information on the plurality of areas (S12). For example, the display target can be narrowed down to the staying timeline 6 of the work area R where the worker W stays in the time span 50, and the amount of information to be analyzed can be reduced.

In the present embodiment, the processor 20 may limit the information to be displayed on the display 23, based on the number of traffic as the frequency at which the moving object moves between the area corresponding to the designated facility E and another area in the detection information on the plurality of areas (S14). For example, the trajectory data D1 indicating trajectories of the moving object may be stored in the memory 21, and the processor 20 may calculate the frequency at which the moving object moves between the area corresponding to the designated facility E and another area, based on the trajectory information (S13). The analysis load can be reduced by the display limitation focusing on the traffic of the moving object.

In the present embodiment, the processor 20 may limit the detection information to be displayed on the display 23 in a manner that the detection information to be displayed is narrowed down from the detection information regarding the plurality of areas and also the order of display in the detection information to be displayed is controlled (S12 and S13). The display limitation of the detection information is not limited thereto, and only one of the narrowing-down of the detection information and the control of the display order may be performed.

In the present embodiment, the processor 20 may limit the operation information to be displayed on the display 23 by excluding the information regarding the facilities E other than the designated facility E among the plurality of facilities E from the operation information to be displayed on the display 23 (S12). As a result, the amount of information to be analyzed can be reduced, and the analysis load can be reduced.

In the present embodiment, the processor 20 causes the operation interface 22 to receive the designating operation of the staying timeline 6, which is an example of detection information operation for designating detection information regarding a specific area in the detection information displayed on the display 23 (S5). In response to the operation on the detection information, the processor 20 causes the display 23 to display the video of the video data DO obtained by imaging a designated area, as an example of the predetermined information on the result of detecting the designated area (86). According to the information analysis device 2 of the present embodiment, it is possible to easily find detection information to be checked before checking predetermined information such as a video. The predetermined information is not limited to the video as described above, and can be various information on the detection information on the moving object.

In the present embodiment, the operation information is the staying timeline 6 that is an example of a first timeline indicating a state where the corresponding facility E operates in chronological order. The detection information is the staying timeline 5 that is an example of a second timeline indicating the detection result of the moving object in the corresponding area in chronological order, With such various timelines 5 and 6, it is possible to easily analyze the information to be displayed regarding each facility E and the moving object in chronological order.

In the present embodiment, provided is an information analysis method for causing a computer to display information on a moving object in the plurality of areas corresponding to the plurality of facilities E. With this method, the memory 21 of the computer stores the operation information indicating a state where each facility E in the plurality of facilities E operates, and the detection information indicating the detection result of the moving object in each area in the plurality of areas. The processor 20 of the computer causes the operation interface 22 to receive the operation for designating information on the specific facility E in the operation information on the plurality of facilities E (S3), and limits the information to be displayed on the display 23 in the operation information on the plurality of facilities E and the detection information on the plurality of areas, based on the information on the facility E designated in the operation in the operation information (S4).

In the present embodiment, a program for causing the computer to perform the above-described information analysis method is provided. The method and the program make it possible for the user to easily analyze the information to be displayed regarding the plurality of facilities E and the moving object that is.

### Second Embodiment

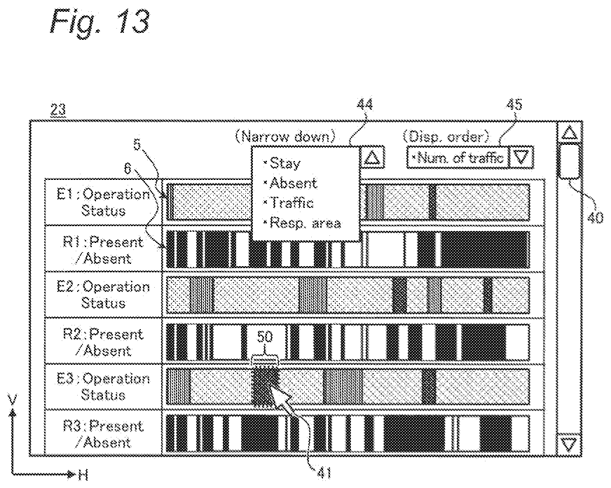

Hereinafter, a second embodiment of the present disclosure will be described with reference to FIGS. 13 to 17. In the first embodiment, the example of the filtering conditions for the timelines 5 and 6 has been described. In the present embodiment, an information analysis device 2 that can use filtering conditions from various viewpoints will be described.

Hereinafter, the information analysis device 2 according to the present embodiment will be described, while the description of the same configurations and operations as those in the trajectory analysis system 1 and the information analysis device 2 according to the first embodiment is omitted as appropriate.

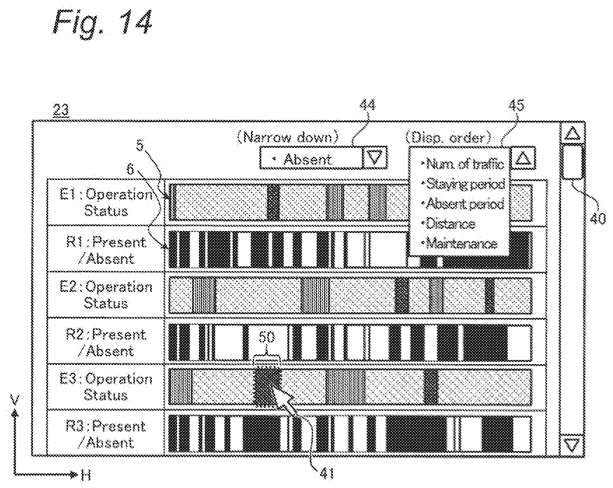

FIGS. 13 and 14 illustrate setting menus 44 and 45 in the information analysis device 2 according to the second embodiment. The information analysis device 2 of the present embodiment is configured to be able to select a condition for narrowing down a staying timeline 6 and a condition of the display order in the configuration similar in the first embodiment.

In the examples of FIGS. 13 and 14, the narrowing-down condition setting menu 44 and the display order condition setting menu 45 are provided as pull-down menus on the analysis screens of the timelines 5 and 6. The setting menu 44 illustrated in FIG. 13 includes the narrowing-down conditions such as “staying”, “absence, “traffic”, and “responsible area” as options. The setting menu 45 illustrated in FIG. 14 includes display order conditions such as “the number of traffic”, “staying period”, “absence period”, “distance”, and “maintenance” as options.

In the examples of FIGS. 13 and 14, the user 15 can select a desired narrowing-down condition and display order condition through an operation on the menus 44 and 45. By performing the designating operation of the operation timeline 5 (S3 in FIG. 8) after the selection of each condition, the filtering of the timelines 5 and 6 can be performed as in the first embodiment.

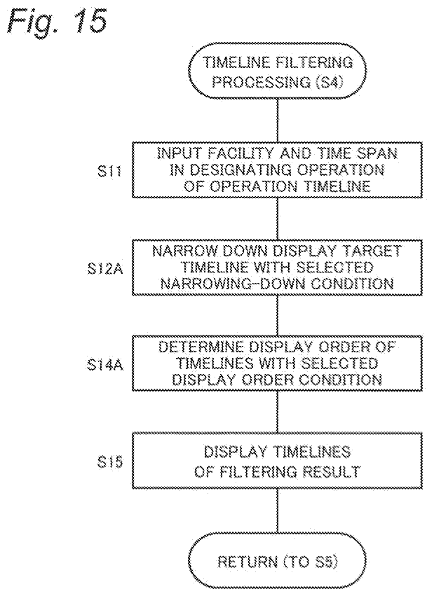

FIG. 15 is a flowchart illustrating timeline filtering processing to be executed by the information analysis device 2 according to the second embodiment. The information analysis device 2 of the present embodiment narrows down the staying timeline 6 and determines the display order in accordance with the selected conditions, instead of steps S12 to S14 of FIG. 10, in the timeline filtering processing (S4 of FIG. 8) similar to that of the first exemplary embodiment (S12A and S14A). In the present embodiment, the counting of the traffic (S13 in FIG. 10) may be performed in steps S12A and 13A in accordance with various conditions, or may be appropriately omitted.

In a case where the “staying” is selected as the narrowing-down condition (see FIG. 13), the processor 20 narrows down the display target to the staying timeline 6 of the work area R where the worker W stays during the time span 50 designated by the designating operation of the operation timeline 5 as in the first embodiment (S12A).

On the other hand, when the narrowing-down condition “absence” is selected, the processor 20 narrows down the display target to the staying timeline 6 of the work area R where the worker W does not stay (i.e., is absent) during the designated time span 50 contrary to the above (S12A). For example, the narrowing condition “absence” is useful for the user 15 who is conducting the analysis and desires to check the work area R where the worker W is absent.

In a case where the narrowing-down condition “traffic” is selected, the processor 20 narrows down the display target to the staying timeline 6 of the work area R where the number of traffic in the work area R3 of the designated facility E3 is a predetermined number (e.g., once) or more, based on traffic information D4 (S12A).

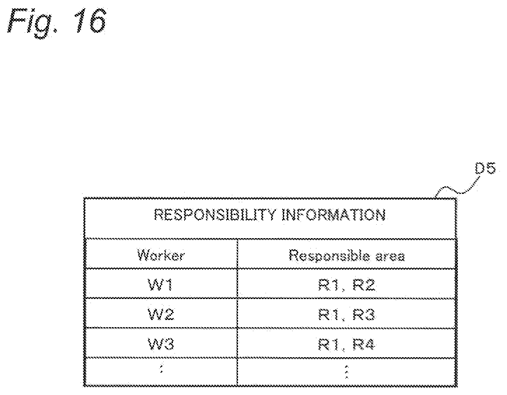

For example, in a case where the narrowing-down condition “responsible area” is selected, the processor 20 narrows down the display target to the staying timeline 6 with reference to responsibility information D5 stored in advance in the memory 21 (12A). An example of the responsibility information D5 is illustrated in FIG. 16.

The responsibility information D5 illustrated in FIG. 16 is an example of management information in which a “worker” for identifying each worker W and a “responsible area” indicating the work area R for which the worker W is responsible are recorded in association with each other. In the example of FIG. 16, the worker W1 is responsible for the plurality of work areas R1 and R2. As described above, in a case where the individual worker W is responsible for the plurality of work areas R, the display target can be narrowed down to the staying timeline 6 of the work area R for which the worker W, who is responsible for the work area R3 of the designated facility E3, is responsible in the narrowing-down condition “responsible area” (S12A).

In a case where the “number of traffic” is selected as the display order condition, the processor 20 gives a higher display priority to the corresponding staying timeline 6 related to the greater number of traffic in the work area R (Sl4A), as in the first embodiment.

For example, in a case where the display order condition “staying period” is selected, the processor 20 gives a higher display priority to the corresponding staying timeline 6 related to the longer staying period in the work area R within the designated time span 50 (S14A).

For example, in a case where the display order condition “absent period” is selected, the processor 20 gives a higher display priority to the corresponding staying timeline 6 related to the longer absent period in the work area R within the designated time span 50 (S14A).

For example, in a case where the display order condition “distance” is selected, the processor 20 gives a higher display priority to the corresponding staying timeline 6 related to a closer distance between the work area R3 of the designated facility E3 and the work area R (S14A). For example, the processor 20 calculates the distance between the work area R3 of the designated facility E3 and the work area R of each facility E with reference to the map information D2. Such a distance is an example of a positional relation between the work area R3 of the designated facility E3 and the work area R.

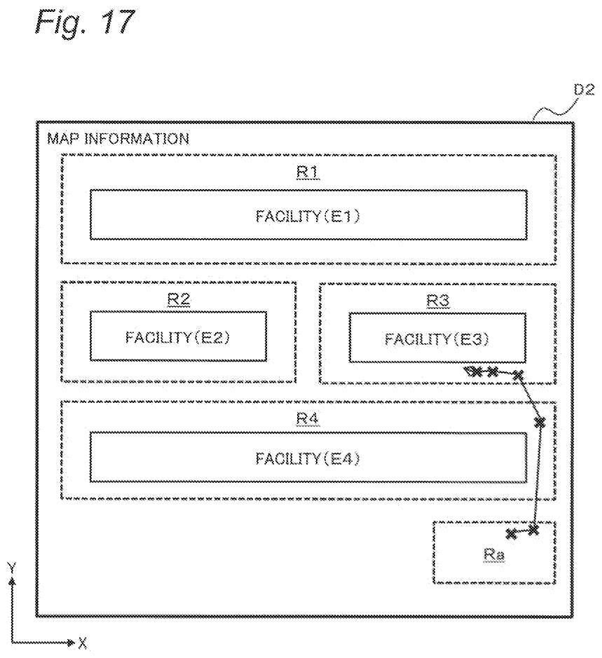

For example, in a case where the display order condition “maintenance” is selected, the processor 20 gives a higher display priority to the staying timeline 6 of the work area R related to the facility E where the worker who is responsible for maintenance of the facility E comes at a higher frequency (S14A). The frequency at which the person responsible for the maintenance arrives will be described with reference to FIG. 17.

FIG. 17 illustrates the map information D2 according to the present embodiment. The map information D2 of this example includes a standby area Ra of the people responsible for maintenance of the facilities E1 to E4. The frequency of arrival of the people responsible for maintenance can be calculated as the number of traffic between the standby area Ra and the work area R of each facility E. For example, the processor 20 calculates the frequency of arrival of the person responsible for maintenance related to the designated facility E3, based on the map information D2 and the trajectory data D1, and sets the above display order (S14A).

As described above, according to the information analysis device 2 of the present embodiment, the timelines 5 and 6 can be filtered using various narrowing-down conditions and display order conditions, and this makes it possible for the user 15 to more easily analyze the timelines 5 and 6.

As described above, in the information analysis device 2 of the present embodiment, the processor 20 may limit the information to be displayed on the display 23, based on the frequency at which the moving object moves back and forth between the standby area Ra, which is an example of a predetermined area different from the plurality of areas corresponding to the plurality of facilities E. and each area of the plurality of areas (S14A). Thus, the display limitation of the staying timeline 6 can be performed in consideration of the arrival frequency of the person responsible for maintenance, for example.

In the information analysis device 2 of the present embodiment, the memory 21 may store the responsibility information D5 which is an example of the management information for managing the moving object responsible for each area in the plurality of areas. The processor 20 may limit the information to be displayed on the display 23 in the detection information on the plurality of areas, with reference to the management information in accordance with the operation in the operation information (S13A). As a result, the display limitation of the staying timeline 6 can be performed in consideration of the overlapping of the work areas R for which the worker W is responsible, for example.

In the information analysis device 2 of the present embodiment, the memory 21 may store the map information D2 indicating the positional relation between the plurality of facilities E and the plurality of areas. The processor 20 may limit the information to be displayed on the display 23 in the detection information on the plurality of areas, based on the positional relation between the facility E designated in the map information and the plurality of areas (S4A). Thus, the display limitation of the staying timeline 6 can be performed in consideration of the distance between facilities E, for example.

In the above description, the conditions for narrowing down the staying timeline 6 and the display order have been exemplified, but the information analysis device 2 of the present embodiment is not particularly limited thereto. For example, the arrival frequency of the person responsible for maintenance and the distance between the facilities E are not used only as the display order condition, and may be used as the narrowing-down condition. The responsibility information D5 may be used as the display order condition. The various conditions described above may be applied not only to the staying timeline 6 but also to the operation timeline 5.

### Other Embodiments

The first and second embodiments have been described above as the examples of the technique disclosed in this application. However, the technique in the present disclosure is not limited thereto, and is applicable also to embodiments in which changes, replacements, additions, omissions and the like are made as appropriate. A new embodiment can be made by combining the components described in the above embodiments. Therefore, other embodiments will be exemplified below.

In the above embodiments, an example of the analysis screen of the information analysis device 2 has been described, but the analysis screen of the information analysis device 2 is not particularly limited thereto. For example, in the present embodiment, the scroll bar 40 may not be particularly provided on the analysis screen of the information analysis device 2, or does not have to receive the slide operation. For example, the analysis screen of the present embodiment may have a format that transitions from the upper side to the lower side for each page.

Each of the above embodiments has described the example of the filtering for excluding the operation timelines 5 of the other facilities E from the display target in a case where the time span 50 such as the error stop span 52 (FIG. 6) of the specific facility E3 is designated by the user operation. The information analysis device 2 of the present embodiment is not limited to the above description, and may display the filtering result including the operation timelines 5 of the other facilities E. For example, when the time span 50 of the specific facility E3 is designated, the processor 20 of the information analysis device 2 may extract the operation timeline 5 having the error stop span 52 temporally continuous with the time span 50 in the operation timelines 5 of other facilities E, and cause the extracted operation timeline 5 to be included in the display targets. As a result, when an error or the like occurs in the specific facility E3, it is possible to easily analyze the situation of the facility E where the error has continuously occurred.

In the above embodiments, the example where the information analysis device 2 generates the staying timeline 6 based on the trajectory data D1 has been described, but the information analysis device 2 of the present embodiment is not limited thereto. In the present embodiment, the staying timeline 6 is not limited to the trajectory data D1, and may be generated from the video data DO of the work area R. The staying timeline 6 may be generated not only by the information analysis device 2 but also by the trajectory management server 12.

In the above embodiments, the staying timeline 6 has been described as an example of the detection information. In the present embodiment, the detection information is not limited to the staying timeline 6, and for example, the number of workers W who stay in the corresponding work area R may be detected, or personal identification may be performed.

In the above embodiments, the example where the work areas R are set respectively to the imaging ranges of the cameras 11 has been described, but the system 1 is not particularly limited thereto. In the present embodiment, the plurality of work areas R may be included in the imaging range of one camera 11, or one work area R may beset across the imaging ranges of the plurality of cameras 11. For example, in response to the designating operation of the staying timeline 6, the information analysis device 2 may display video data including at least a part of an imaging result of the corresponding work area R. The correspondence relation between the facilities E and the work areas R is not necessarily limited to a one-to-one relation, and for example, the plurality of work areas R may be in correspondences with one facility E, or one work area R may be in correspondences with the plurality of facilities E.

In the above embodiments, the worker W has been described as the example of the moving object. In the present embodiment, the moving object may be a person who is not the worker W, or may be a living being, various vehicles, robots, or the like without being limited to the person.

The embodiments are described above as the example of the technique in the present disclosure. For this reason, the accompanying drawings and detailed description are provided.

Therefore, the components described in the accompanying drawings and the detailed description may include not only the components essential for solving the problem but also the components not essential for solving the problem for illustrating the above-mentioned technique. Therefore, it should not be immediately construed that these components that are not essential are essential even if the unessential components are described in the accompanying drawings and the detailed description.

Further, since the above-described embodiments are for exemplifying the technique in the present disclosure, various changes, replacements, additions, omissions and the like can be made within the scope of claims or their equivalents.

The present disclosure is applicable to information analysis regarding a work area or the like of a facility in various fields such as a factory or distribution.

1. An information analysis device for displaying information on a moving object in plural areas corresponding to plural facilities, the information analysis device comprising:
a display configured to display information;
an input interface configured to receive a user operation;
a processor configured to control the display, based on the user operation received by the input interface; and
a memory configured to store status information and detection information, the status information indicating a state where each facility in the plural facilities operates, and the detection information indicating a detection result of the moving object in each area in the plural areas,
wherein the processor is configured to:
receive a status information operation via the input interface, the status information operation designating information on a specific facility in the status information on the plural facilities; and
limit information to be displayed on the display among the status information on the plural facilities and the detection information on the plural areas, based on information on the specific facility designated by the status information operation.

2. The information analysis device according to claim 1,
wherein the status information on the plural facilities includes time spans each in which each facility is a predetermined state,
wherein the information on the specific facility, which is designated by the status information operation, indicates a time span in which the specific facility is the predetermined state, and
wherein the processor is configured to cause the limited detection information, which is to be displayed on the display, to include the detection result of the moving object in the time span designated by the status information operation.

3. The information analysis device according to claim 2, wherein the processor is configured to limit the information to be displayed on the display among the detection information on the plural areas, based on the detection result of the moving object within the designated time span in each of the plural areas.

4. The information analysis device according to claim 1, wherein the processor is configured to limit the information to be displayed on the display among the detection information on the plural areas, based on a frequency at which the moving object moves between an area corresponding to the specific facility and the other areas.

5. The information analysis device according to claim 1, wherein the processor is configured to limit the information to be displayed on the display, based on a frequency at which the moving object moves between a predetermined area and any area of the plural areas, the predetermined area being different from the plural areas corresponding to the plural facilities.

6. The information analysis device according to claim 1,
wherein the memory is configured to store management information managing a responsible moving object for each area among the plural areas, and
wherein the processor is configured to limit the information to be displayed on the display among the detection information on the plural areas, referring to the management information in response to the status information operation.

7. The information analysis device according to claim 1,
wherein the memory is configured to store map information indicating positional relation between the plural facilities and the plural areas, and
wherein the processor is configured to limit the information to be displayed on the display among the detection information on the plural areas, based on positional relation between an area corresponding to the specific facility and the plural areas in the map information.

8. The information analysis device according to claim 1, wherein the processor is configured to limit the detection information to be displayed on the display by at least one of: narrowing down the detection information on the plural areas to the detection information to be displayed; or controlling a display order of the detection information to be displayed.

9. The information analysis device according to claim 1, wherein the processor is configured to limit the status information to be displayed on the display by excluding information on facilities other than the specific facility among the plural facilities, from the status information to be displayed on the display.

10. The information analysis device according to claim 1,
wherein the processor is configured to:
receive a detection information operation via the input interface, the detection information operation designating detection information on a specific area in the detection information displayed on the display; and
cause the display to display predetermined information related to a detection result of the specific area, in response to the detection information operation.

11. The information analysis device according to claim 1,
wherein the status information is a first timeline indicating a state where a corresponding facility operates in chronological order, and
wherein the detection information is a second timeline indicating a detection result of the moving object in a corresponding area in chronological order.

12. An information analysis method for causing a computer to display information on a moving object in plural areas corresponding to plural facilities, the information analysis method comprising:
causing a memory of the computer to store status information and detection information, the status information indicating a state where each facility in the plural facilities operates, and the detection information indicating a detection result of the moving object in each area in the plural areas; and
causing a processor of the computer to:
receive a status information operation via an input interface, the status information operation designating information on a specific facility in the status information on the plural facilities; and
limit information to be displayed on a display among the status information on the plural facilities and the detection information on the plural areas, based on information on the specific facility designated by the operation in the status information.

13. A non-transitory computer-readable recording medium storing a program for causing a processor of a computer to perform the information analysis method according to claim 12.

14. The information analysis device according to claim 1,
wherein the processor is configured to exclude non-designated status information from the status information to be displayed, the non-designated status information indicating a state of another facility than the specific facility, which is designated by the status information operation, among the plural facilities.
